(19) United States
(12) Patent Application Publication
(10) Pub. No.: US 2012/0177399 A1
(43) Pub. Date: Jul. 12, 2012

(54) DEVELOPING UNIT AND IMAGE FORMING APPARATUS INCLUDING THE SAME

(75) Inventors: Dae Ho KIM, Hwaseong-si (KR); Se Il Kwon, Yongin-si (KR)

(73) Assignee: Samsung Electronics Co., Ltd., Suwon-si (KR)

(21) Appl. No.: 13/339,766

(22) Filed: Dec. 29, 2011

(30) Foreign Application Priority Data
Jan. 6, 2011 (KR) 10-2011-0001295

(51) Int. Cl. G03G 21/18; G03G 15/08

(52) U.S. Cl. 399/111; 399/258

(57) ABSTRACT

A developing unit and an image forming apparatus including the developing unit. The image forming apparatus includes a main body, a developing cartridge detachably mounted at the main body while having a photosensitive body to form an electrostatic latent image, a toner cartridge detachably mounted at the main body to supply the developing cartridge with toner, at least one first position regulating member provided at the developing cartridge, the first position regulating member to regulate a relative position between the developing cartridge and the toner cartridge when the toner cartridge is mounted at the main body, and at least one second position regulating member provided at the toner cartridge, the second position regulating member to come into contact with the first position regulating member to regulate the relative position between the developing cartridge and the toner cartridge.

### CROSS-REFERENCE TO RELATED APPLICATIONS

This application claims priority under 35 U.S.C. §119 from Korean Patent Application No. 10-2011-0001295 filed on Jan. 6, 2011 in the Korean Intellectual Property Office, the disclosure of which is incorporated herein by reference in its entirety.

### BACKGROUND

1. Field of the Invention

The present general inventive concept relates to a developing unit and an image forming apparatus including the developing unit, the developing unit having a structure capable of regulating a relative positional relationship between a developing cartridge and a toner cartridge which are mounted within the image forming apparatus.

2. Description of the Related Art

Image forming apparatuses are used to form an image on a printing medium according to an input signal. Examples of such an image forming apparatus include a printer, a copier, a facsimile device, and a combination device integrating functions thereof. The image forming apparatus includes a main body to support or drive a variety of parts thereof while loading or supplying sheets of paper, and a developing unit mounted at the main body to form the image on each sheet of paper.

The developing units may be classified into one-piece type and two-piece type developing units, etc., in accordance with printing speed, developing mode, system layout, and the like. In the one-piece type developing unit, a part to form an image and a part to supply toner are provided in one developing unit to be not independent of each other. In contrast, in the two-piece type developing unit, the part to form the image and the part to supply the toner are divided into a developing cartridge and a toner cartridge, respectively to be separately mounted at the main body of the image forming apparatus.

The two-piece type developing unit has a conventional structure in which the toner stored in the toner cartridge is supplied to the developing cartridge, and then waste toner, which is used and remains in the developing cartridge, is discharged to the toner cartridge again. In such a structure, when a relative positional relationship between the developing cartridge and the toner cartridge is not regulated within a constant error range, the toner or the waste toner may not be smoothly supplied or discharged, or may leak out of the developing or toner cartridge during a of movement of the toner from the toner cartridge to the developing cartridge or a movement of the waste toner from the developing cartridge to the toner cartridge.

### SUMMARY

The present general inventive concept provides a developing unit and an image forming apparatus including the developing unit, the developing unit having an improved structure in which, when mounted within a main body of the image forming apparatus, a developing cartridge and a toner cartridge may be regulated within a constant error range.

Additional features and utilities of the present general inventive concept will be set forth in part in the description which follows and, in part, will be obvious from the description, or may be learned by practice of the general inventive concept.

The foregoing and/or other features and utilities of the general inventive concept may be achieved by providing an image forming apparatus including a main body, a developing cartridge detachably mounted at the main body while having a photosensitive body to form an electrostatic latent image, a toner cartridge detachably mounted at the main body to supply the developing cartridge with toner, at least one first position regulating member provided at the developing cartridge, the first position regulating member to regulate a relative position between the developing cartridge and the toner cartridge when the toner cartridge is mounted at the main body, and at least one second position regulating member provided at the toner cartridge, the second position regulating member to come into contact with the first position regulating member to regulate the relative position between the developing cartridge and the toner cartridge.

The developing cartridge may include a toner receiving portion which is supplied with the toner from the toner cartridge, the toner cartridge may include a toner discharge portion to supply the toner through the toner receiving portion, and the first and second position regulating members may come into contact with each other to regulate a positional relationship between the toner receiving portion and the toner discharge portion.

The developing cartridge may include a waste toner discharge portion to discharge waste toner to the toner cartridge, the toner cartridge may include a waste toner receiving portion to receive the waste toner discharged through the waste toner discharge portion, and the first and second position regulating members may come into contact with each other to regulate a positional relationship between the waste toner discharge portion and the waste toner receiving portion.

The first position regulating member may have a receiving portion provided at a periphery of the toner receiving portion to receive the second position regulating member when the toner cartridge is mounted at the main body.

The second position regulating member may have a protrusion which protrudes from a front portion of the toner discharge portion in a mounting direction of the toner cartridge, and the protrusion may be received at the receiving portion when the toner cartridge is mounted at the main body.

The receiving portion may include a cover portion to regulate a position of the protrusion in upward and downward directions, and a side wall portion connected with one side or both sides of the cover portion to regulate a position of the protrusion in left and right directions.

The toner receiving portion may be provided, at an upper portion thereof, with a first shield member to selectively block the toner receiving portion, and the toner discharge portion may be provided, at the front portion thereof, with a first pressure portion to press and move the first shield member when the toner cartridge is mounted.

The first position regulating member may have a guide portion provided at one side of the waste toner discharge portion to guide the second position regulating member when the toner cartridge is mounted at the main body.

The second position regulating member may have a slide portion provided at a periphery of the waste toner receiving portion to come into contact with the guide portion when the toner cartridge is mounted at the main body so as to slide in a mounting direction of the toner cartridge.

The waste toner discharge portion may include a side cover coupled to one side of a housing, a waste toner feeding belt to feed the waste toner received at a space which is defined by the housing and the side cover, and a waste toner outlet to which the waste toner fed by the waste toner feeding belt is discharged, wherein the guide portion may have a contact surface formed to protrude from one side of the side cover to come into contact with the slide portion.

The waste toner receiving portion may be provided, at an upper portion thereof, with a second shield member to selectively block the waste toner receiving portion, and the side cover may be provided, at a front portion thereof, with a second pressure portion to press and move the second shield member when the toner cartridge is mounted.

The main body may be coupled, at opposite sides thereof, with guide members so as to guide the developing cartridge or the toner cartridge, each of the guide members having at least one guide groove, and the developing cartridge or the toner cartridge may be provided, at each of opposite sides thereof, with at least one guide protrusion, which is received at the guide groove when the developing cartridge is mounted at the main body.

The guide groove may include an upper guide groove to support the toner cartridge and a lower guide groove to support the developing cartridge or the toner cartridge.

The at least one guide protrusion, which is provided at each of the opposite sides of the developing cartridge or the toner cartridge, may be provided, at an inner side thereof, with a drive coupler to rotate rollers within the developing cartridge or the toner cartridge.

The foregoing and/or other features and utilities of the general inventive concept may also be achieved by providing a developing unit including a developing cartridge to form an image on a printing medium and a toner cartridge to supply the developing cartridge with toner, wherein the developing cartridge includes a housing which has a toner receiving portion and a waste toner discharge portion, a photosensitive body rotatably coupled within the housing to form an electrostatic latent image, at least one agitating screw to agitate the toner supplied through the toner receiving portion to feed the toner to the photosensitive body, a cleaning member to remove waste toner remaining on the photosensitive body, a waste toner feeding screw to feed the waste toner removed by the cleaning member to one side of the housing, a waste toner feeding belt to guide the waste toner fed by the waste toner feeding screw to the waste toner discharge portion, and at least one first position regulating member provided at a periphery of the waste toner discharge portion, the first position regulating member coming into contact with the toner cartridge to regulate a relative position between the developing cartridge and the toner cartridge.

The toner cartridge may include a waste toner receiving portion to come into contact with the waste toner discharge portion to receive the waste toner discharged through the waste toner discharge portion, and at least one second position regulating member provided at a periphery of the waste toner receiving portion, the second position regulating member coming into contact with the first position regulating member to regulate the relative position between the developing cartridge and the toner cartridge.

The first position regulating member may have a guide portion which protrudes from one side of the waste toner discharge portion to guide the second position regulating member when the toner cartridge is mounted at the main body.

The second position regulating member may have a slide portion which is provided at the periphery of the waste toner receiving portion to come into contact with the guide portion when the toner cartridge is mounted at the main body so as to slide in a mounting direction of the toner cartridge.

The foregoing and/or other features and utilities of the general inventive concept may also be achieved by providing a developing unit including a developing cartridge to form an image on a printing medium and a toner cartridge to supply the developing cartridge with toner, wherein the developing cartridge includes a housing which has a toner receiving portion, a photosensitive body rotatably coupled within the housing to form an electrostatic latent image, at least one agitating screw to agitate the toner supplied through the toner receiving portion to feed the toner to the photosensitive body, and at least one first position regulating member provided at a periphery of the waste toner discharge portion, the first position regulating member coming into contact with the toner cartridge to regulate a relative position between the developing cartridge and the toner cartridge.

The toner cartridge may include a toner supply portion to come into contact with the toner receiving portion to supply the toner receiving portion with the toner, and at least one second position regulating member provided at one side of the toner supply portion, the second position regulating member coming into contact with the first position regulating member to regulate the relative position between the developing cartridge and the toner cartridge.

The first position regulating member may have a receiving portion to receive the second position regulating member when the toner cartridge is mounted at the main body, and the receiving portion may include a cover portion to regulate a position of the second position regulating member in upward and downward directions.

The second position regulating member may have a protrusion which protrudes from a front portion of the toner discharge portion in a mounting direction of the toner cartridge, and the protrusion may be received at the receiving portion when the toner cartridge is mounted at the main body.

The foregoing and/or other features and utilities of the general inventive concept may also be achieved by providing an image forming apparatus including a developing cartridge to supply toner to a printing medium, a toner cartridge detachably coupled to the developing cartridge to supply the developing cartridge with the toner, and a position regulating member to regulate a relative position between the developing cartridge and the toner cartridge when the toner cartridge is coupled to the developing cartridge.

The position regulating member may include a first position regulating member coupled to one of the developing cartridge or the toner cartridge and a second position regulating member coupled to the other one of the developing cartridge or the toner cartridge to contact the first position regulating member to regulate the relative position between the developing cartridge and the toner cartridge.

The contact between the first position regulating member and the second position member prevents the toner cartridge from moving in at least one of a vertical direction and a horizontal direction with respect to the developing cartridge.

The image forming apparatus may further include a toner receiving portion to permit the developing cartridge to receive the toner from the toner cartridge, and a toner discharge portion to supply the toner to the toner receiving portion.

The first position regulating member may contact the second position regulating member to regulate a positional relationship between the toner receiving portion and the toner discharge portion.

The image forming apparatus may further include a waste toner discharge portion to discharge waste toner from the developing cartridge to the toner cartridge, and a waste toner receiving portion to permit the toner cartridge to receive the waste toner discharged from the waste toner discharge portion.

The first position regulating member may contact the second position regulating member to regulate a positional relationship between the waste toner discharge portion and the waste toner receiving portion.

The image forming apparatus may further include a shield member elastically coupled to at least one of the developing cartridge and the toner cartridge to prevent the toner from exiting from the at least one of the developing cartridge and the toner cartridge when the toner cartridge is detached from the developing cartridge.

The shield member may be moved to allow the toner to exit the at least one of the developing cartridge and the toner cartridge when the toner cartridge is coupled to the developing cartridge.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically illustrating a configuration of an image forming apparatus according to an exemplary embodiment of the present general inventive concept;

FIG. 2 is a perspective view illustrating coupling of a developing cartridge and a toner cartridge according to an exemplary embodiment of the present general inventive concept;

FIG. 3 is a perspective view illustrating the developing cartridge according to an exemplary embodiment of the present general inventive concept;

FIG. 4 is a perspective view illustrating a portion of the developing cartridge selected from FIG. 3;

FIG. 5 is a sectional view taken along line I-I of FIG. 3;

FIG. 6 is an expanded perspective view of portion ‘A’ illustrated in FIG. 3;

FIG. 7 is an expanded perspective view of portion ‘B’ illustrated in FIG. 3;

FIG. 8 is a perspective view illustrating the toner cartridge according to an exemplary embodiment of the present general inventive concept;

FIG. 9 is a sectional view taken along line II-II of FIG. 8;

FIGS. 10A and 10B are expanded perspective views of portion ‘C’ illustrated in FIG. 8 as viewed from different directions;

FIG. 11 is an expanded perspective view of portion ‘D’ illustrated in FIG. 8;

FIG. 12 is a perspective view illustrating a coupling form of the developing cartridge and the toner cartridge;

FIG. 13 is an expanded perspective view of portion ‘E’ illustrated in FIG. 12;

FIG. 14 is an expanded perspective view of portion ‘F’ illustrated in FIG. 12;

FIG. 15 is a sectional view illustrating a positional relationship between a toner discharge portion and a toner receiving portion when the toner cartridge is mounted;

FIG. 16 is a side view separately illustrating a left guide member illustrated in FIG. 2; and

FIG. 17 is a side view separately illustrating a right guide member illustrated in FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

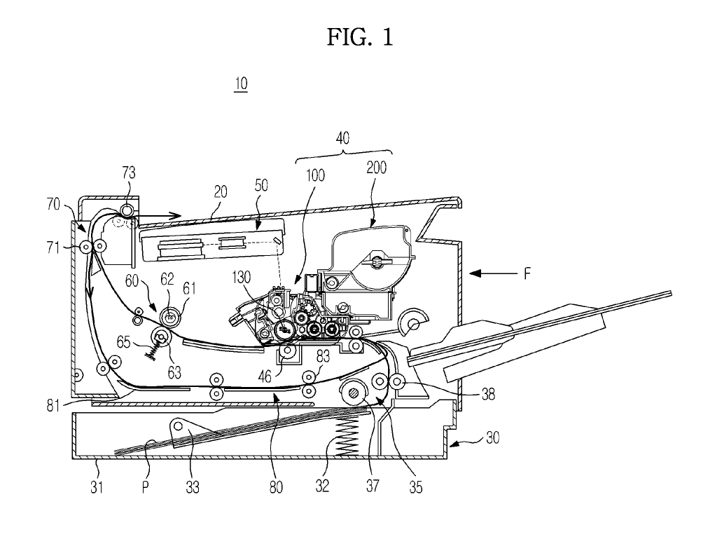

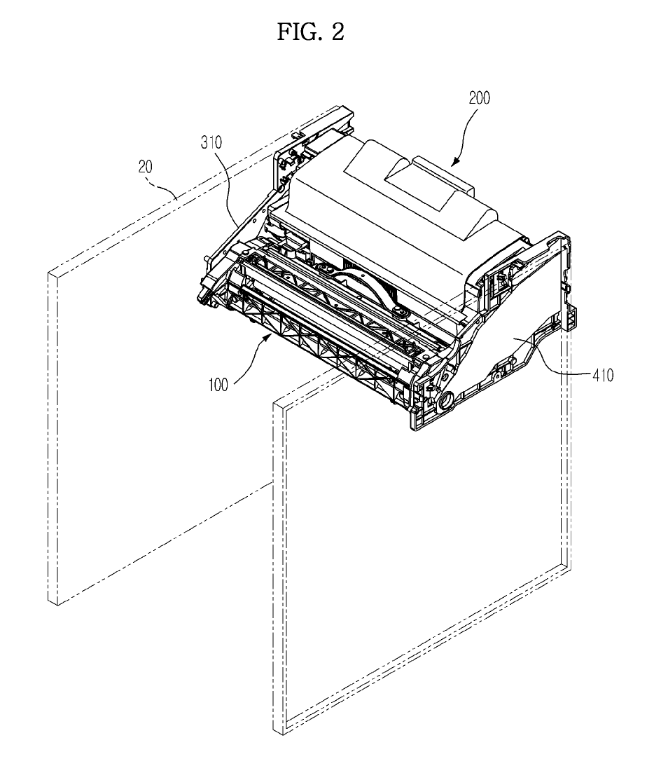

FIG. 1 is a view schematically illustrating a configuration of an image forming apparatus 10 according to an exemplary embodiment of the present general inventive concept. FIG. 2 is a perspective view illustrating coupling of a developing cartridge 100 and a toner cartridge 200 according to an exemplary embodiment of the present general inventive concept.

As illustrated in FIG. 1, the image forming apparatus 10 includes a main body 20 to define an external appearance thereof, a paper supply unit 30 to store and feed printing media P, a developing unit 40 to form an image on each printing medium P supplied through the paper supply unit 30, an optical exposure unit 50 to form an electrostatic latent image on a photosensitive body 130 of the developing unit 40, a developer pressing roller 46 to press the printing medium P against the photosensitive body 130 to transfer the electrostatic latent image to the printing medium P, a fixing unit 60 to fix a developer image transferred to the printing medium P to the printing medium P, a paper discharge unit 70 to discharge the printing medium P on which image formation is completed to the outside of the main body 20, and a double-sided printing unit 80 to retransfer the printing medium P in a state in which image formation is completed on one side thereof to the developing unit 40 again.

The paper supply unit 30 stores and feeds the printing media P, and is provided at a lower portion of the main body 20 to supply the printing media P toward the developing unit 40.

Such a paper supply unit 30 may include a cassette type paper supply tray 31 which stores the printing media P and is able to be withdrawn from the main body 20, and a feeding unit 35 to pick up the printing media P stored in the paper supply tray 31 sheet by sheet to feed the picked-up printing medium P toward the developing unit 40.

The paper supply tray 31 may be provided, at an inner portion thereof, with a knock-up plate 33. The knock-up plate 33 is rotatably coupled, at one end thereof, with the paper supply tray 31 while being supported, at another end thereof, by a pressure spring 32 to guide the printing media P loaded on the knock-up plate 33 toward the feeding unit 35.

The feeding unit 35 may include a pick-up member 37 to pick up the printing media P loaded on the knock-up plate 33 sheet by sheet and roller type feeding members 38 to feed the printing medium P picked up by the pick-up member 37 toward the developing unit 40.

The optical exposure unit 50 scans light including image information to the photosensitive body 130 to form the electrostatic latent image on the photosensitive body 130.

The printing medium P passes in between the photosensitive body 130 and the developer pressing roller 40 to allow the electrostatic latent image to be transferred to the printing medium P.

The fixing unit 60 applies heat and pressure to the printing medium P to fix the developer image formed on the printing medium P to the printing medium P.

This fixing unit 60 includes a heating member 61 with a built-in heat source 62, and a pressure roller 63 to press the printing medium P against the heating member 61.

The heat source 62 may include heating elements such as a heater, a heating lamp, and a hot wire to heat the heating member 61.

The heating member 61 may be formed as a roller type member built into the heat source 62, or a belt type member heated by the heat source 62.

The pressure roller 63 comes into close contact with the heating member 61 while being supported by an elastic member 65 so that a uniform fixing pressure is maintained between the pressure roller 63 and the heating member 61. A plurality of pressure rollers 63 may be provided.

Therefore, the fixing unit 60 applies heat and pressure to a visible image transferred to the printing medium P in the course of passing of the printing medium P between the heating member 61 and the pressure roller 63, so that the visible image is fused and adhered to the printing medium P.

The paper discharge unit 70 includes a first delivery roller 71 and a second delivery roller 73 which are sequentially installed so as to discharge the printing medium P passing through the fixing unit 60 to the outside of the main body 20.

The double-sided printing unit 80 retransfers the printing medium P in the state in which image formation is completed on one side thereof to the developing unit 40 again so that both sides of the printing medium P may be printed upon.

The double-sided printing unit 80 may include double-sided printing guides 81 to define a retransfer route of the printing medium P, and retransfer rollers 83 mounted on the retransfer route of the printing medium P to feed the printing medium P.

During the double-sided printing, the printing medium P in the state in which image formation is completed on one side thereof is reversed at a particular time point to is guided to the double-sided printing guides 81 in the middle of being discharged by the second delivery rollers 73, and is then fed to the developing unit 40 again by the retransfer rollers 83. Subsequently, the printing medium P is formed, at the other side thereof, with the image while passing through the developing unit 40 and the fixing unit 60.

The image forming apparatus 10 according to an exemplary embodiment of the present general inventive concept has a front in front out (FIFO) structure in which the printing medium P is introduced from a front portion F of the main body 20 to perform a printing process within the main body 20, and is then discharged to the front portion F of the main body again. That is, a user pulls the paper supply tray 31 in a frontward direction of the main body 20 to supply the printing medium P, and then the printing medium P on which printing has been completed is discharged in the frontward direction of the main body 20. Accordingly, when viewed from the side as illustrated in FIG. 1, the printing medium P is fed along a substantially ‘S’ shaped route within the main body 20. The printing medium P is introduced from or discharged to the front portion F of the main body 20, and a user may receive and see sheets of paper output from the front portion F in a state equal to a printing direction, thereby providing an excellent handling property. In addition, the main body 20 may be reduced in size, in particular in width with regard to left and right directions, instead of having a somewhat complex feeding route of the printing medium P, thereby utilizing space in a more efficient manner.

As illustrated in FIG. 2, the developing unit 40 includes the developing cartridge 100 to form the image on the printing medium P fed from the paper supply unit 30, and the toner cartridge 200 mounted at an upper portion of the developing cartridge 100 to supply toner to the developing cartridge 100.

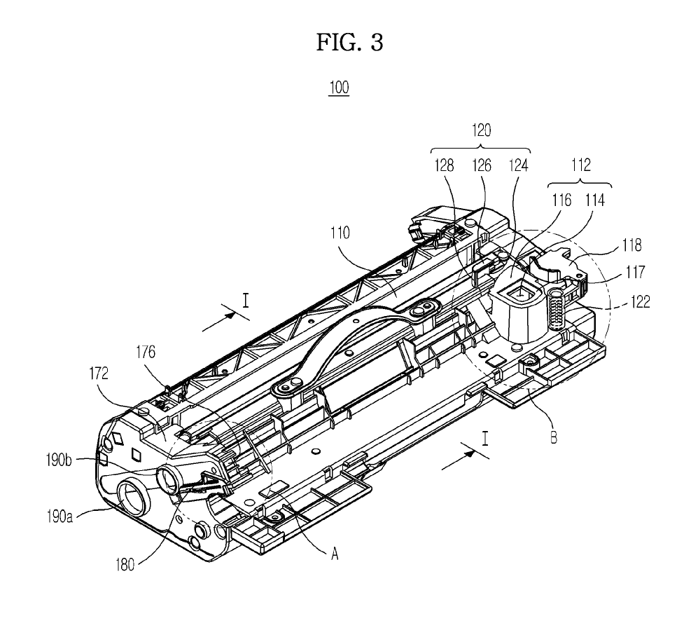

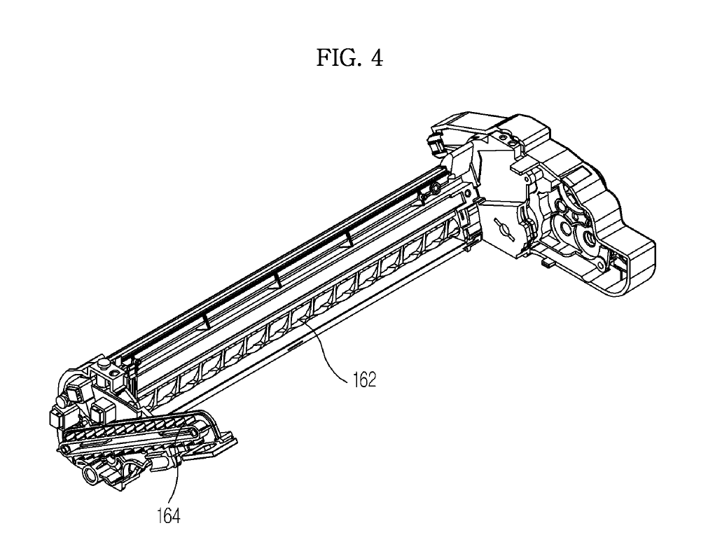

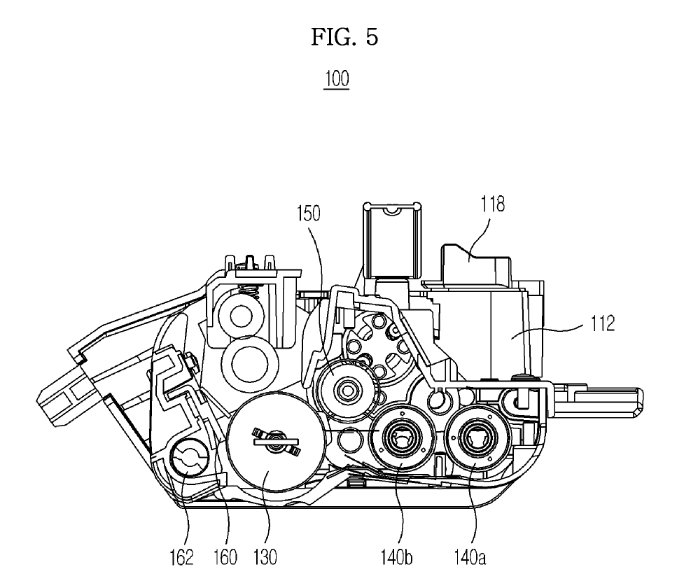

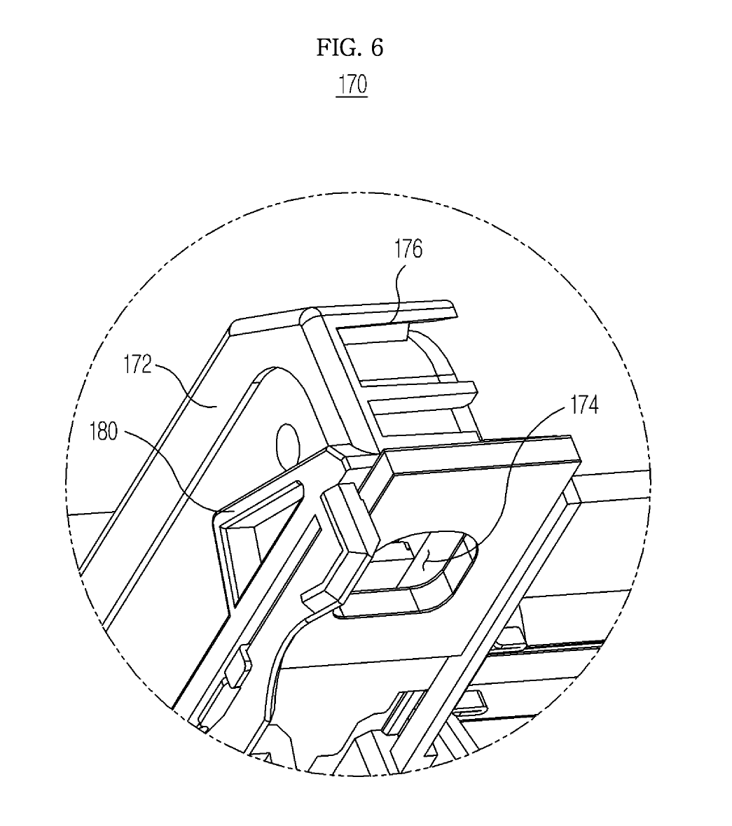

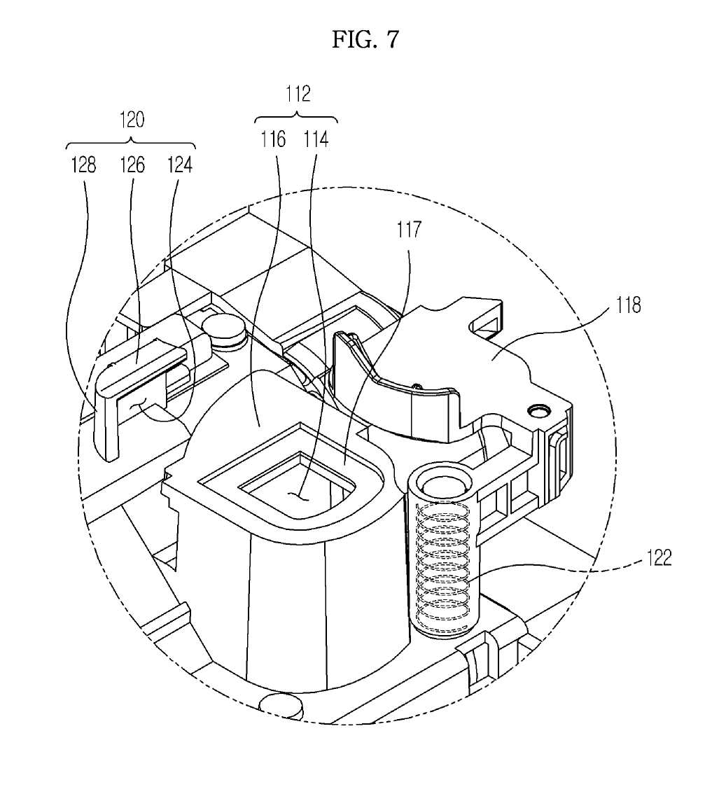

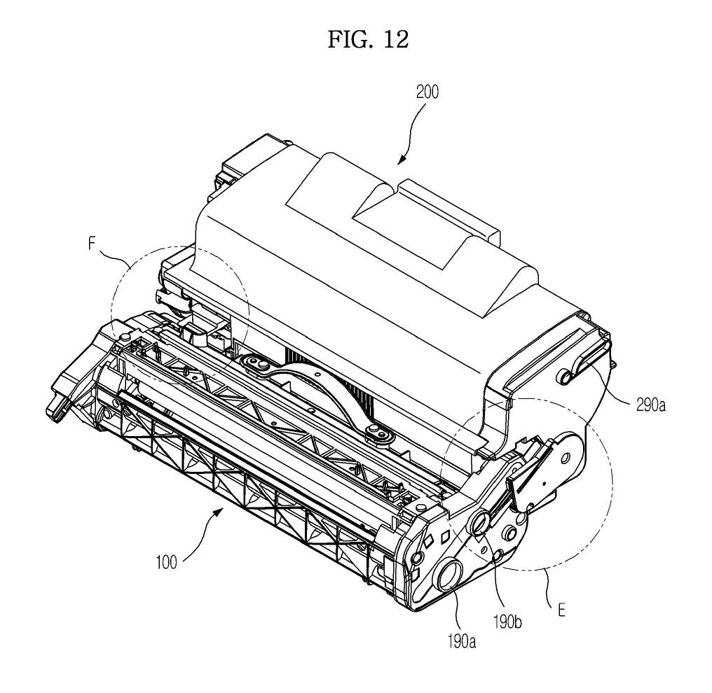

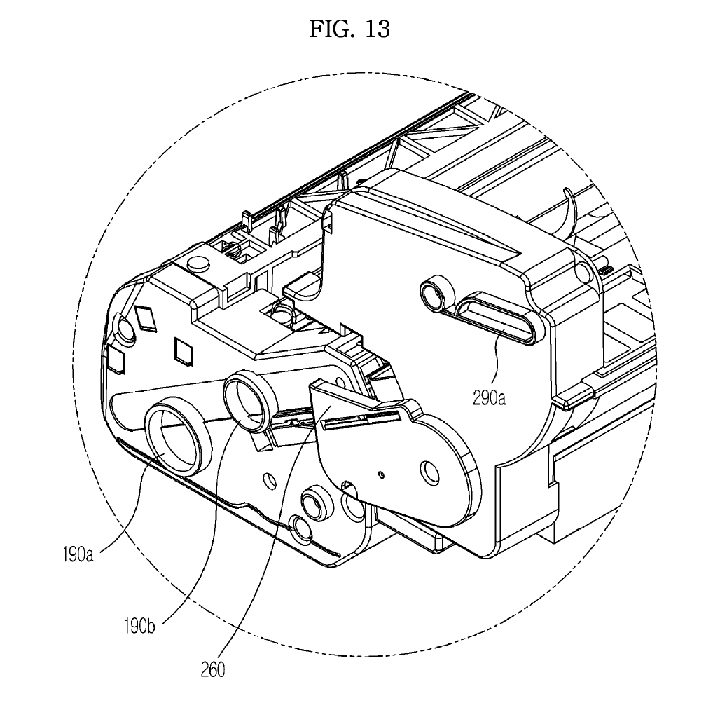

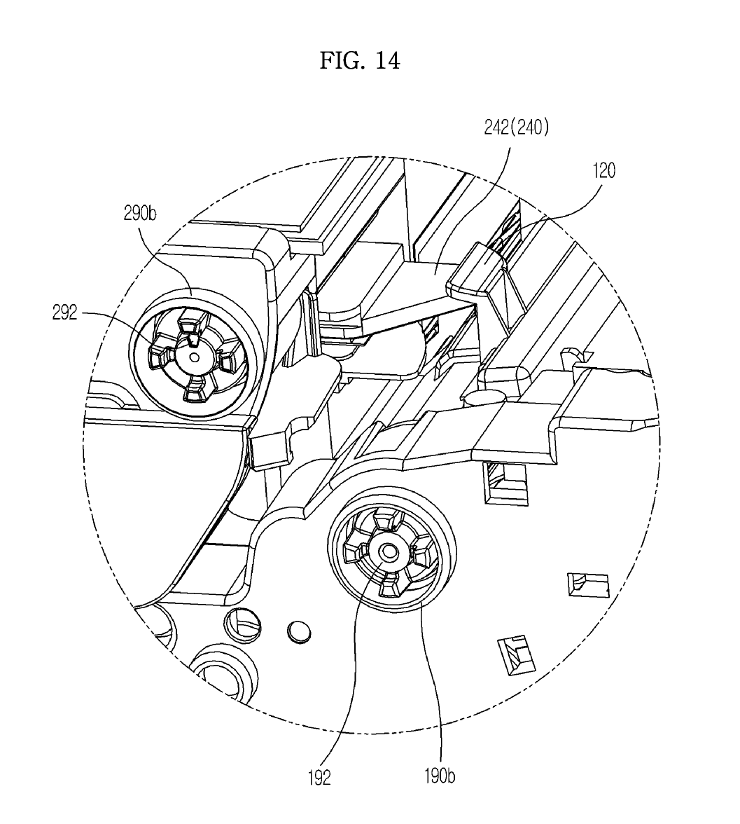

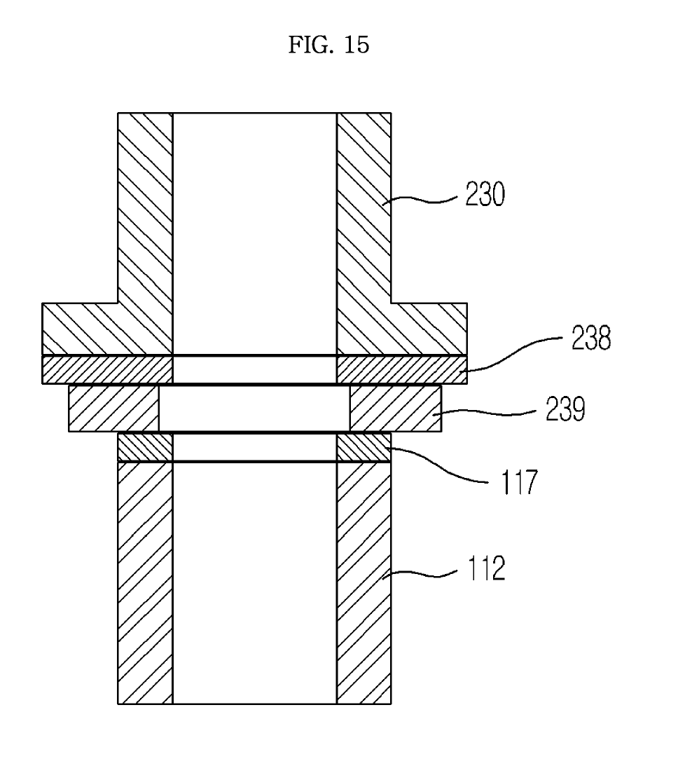

FIG. 3 is a perspective view illustrating the developing cartridge 100 according to an exemplary embodiment of the present general inventive concept. FIG. 4 is a perspective view illustrating a portion of the developing cartridge 100 selected from FIG. 3. FIG. 5 is a sectional view taken along line I-I of FIG. 3. FIG. 6 is an expanded perspective view of portion ‘A’ illustrated in FIG. 3. FIG. 7 is an expanded perspective view of portion ‘B’ illustrated in FIG. 3. FIG. 12 is a perspective view illustrating a coupling form of the developing cartridge 100 and the toner cartridge 200. FIG. 13 is an expanded perspective view of portion ‘E’ illustrated in FIG. 12. FIG. 14 is an expanded perspective view of portion ‘F’ illustrated in FIG. 12. FIG. 15 is a sectional view illustrating a positional relationship between a toner discharge portion 170 and a toner receiving portion 112 when the toner cartridge 200 is mounted.

As illustrated in FIGS. 3 through 7 and 12 through 15, the developing cartridge 100 includes a housing 110 to define an external appearance thereof, the photosensitive body 130 rotatably coupled within the housing 110 to form the electrostatic latent image, agitating screws 140a and 140b to agitate the toner supplied from the toner cartridge 200, a developing roller 150 to supply the toner agitated by the agitating screws 140a and 140b to the photosensitive body 130, a cleaning member 160 to remove waste toner remaining on a surface of the photosensitive body 130, a first waste toner feeding screw 162 to feed the waste toner removed by the cleaning member 160 to one side of the housing 110, and a waste toner feeding belt 164 provided at the side of the housing 110 to guide the waste toner fed by the first waste toner feeding screw 162 to the waste toner discharge portion 170.

The toner supplied from the toner cartridge 200 is introduced into the housing 110 to be agitated and fed to one side of the housing 110 by the agitating screws 140a and 140b. Subsequently, the toner, which is agitated and fed, is supplied to the photosensitive body 130 by the developing roller 150 to form the visible image thereupon. Meanwhile, toner that has not been transferred from the photosensitive body 130 to the printing medium P is removed by the cleaning member 160 arranged to come into contact with the surface of the photosensitive body 130, and is then fed to the first waste toner feeding screw 162 located at a lower portion of the cleaning member 160. Subsequently, the first waste toner feeding screw 162 feeds the waste toner removed by the cleaning member 160 to one side of the housing 110 via the waste toner feeding belt 164. The waste toner feeding belt 164 changes a feeding direction of the waste toner fed thereto so that the waste toner may be guided to the waste toner discharge portion 170 and then be discharged out of the developing cartridge 100.

The housing 110 is provided with the toner receiving portion 112 supplied with the toner carried in the toner cartridge 200, and the waste toner discharge portion 170 to discharge the waste toner to the toner cartridge 200.

The toner receiving portion 112 protrudes upwards from a substantially front portion of the housing 110. The toner receiving portion 112 is provided, at an upper portion thereof, with a toner inlet 114 and a support surface 116. The toner inlet 114 introduces the toner supplied from the toner cartridge 200 into the housing 110, and the support surface 116 supports the toner cartridge 200 when the toner cartridge 200 is coupled to the developing cartridge 100. The support surface 116 is coupled, at an upper surface thereof, with a first sealing member 117 to prevent the toner from leaking between the toner discharge portion 230 and the toner inlet 114.

A first shield member 118 is located at a periphery of the toner receiving portion 112 to selectively open or close the toner inlet 114. The first shield member 118 is coupled, at one end thereof, with a first elastic member 122. Consequently, the first shield member 118 is elastically biased by the first elastic member 122 to close the toner inlet 114 in a state in which the toner cartridge 200 is not coupled to the developing cartridge 100. Additionally, the first shield member 118 is pressed by a first pressure portion 236 provided at the toner cartridge 200 to open the toner inlet 114 when the toner cartridge 200 is coupled to the developing cartridge 100. When replacing the developing cartridge 100, a user separates the developing cartridge 100 from the toner cartridge 200. Accordingly, the first shield member 118 closes the toner inlet 114 when the developing cartridge 100 is separated from the toner cartridge 200, as described above. Therefore, the toner is prevented from leaking through the toner inlet 114 during a replacement of the developing cartridge 100.

Furthermore, the toner receiving portion 112 is formed, at the periphery thereof, with a first position regulating member 120 to regulate a relative position between the developing cartridge 100 and the toner cartridge 200 when the toner cartridge 200 is mounted at the main body 20.

The first position regulating member 120 includes a receiving portion 124 to receive a second position regulating member 240 provided at the toner cartridge 200. The receiving portion 124 includes a cover portion 126 to regulate a position of the second position regulating member 240 in upward and downward directions, and a side wall portion 128 connected with one side or both sides of the cover portion 126 to regulate a position of the second position regulating member 240 in left and right directions.

The waste toner discharge portion 170 is provided at one side of the housing 110. The waste toner discharge portion 170 includes a side cover 172 coupled to the side of the housing 110 to receive the waste toner fed by the first waste toner feeding screw 162 together with the housing 110, a waste toner feeding belt 164 to upwardly feed the waste toner received at a space which is defined by the housing 110 and the side cover 172, and a waste toner outlet 174 to which the waste toner fed by the waste toner feeding belt 164 is discharged.

The side cover 172 is formed, at a front portion thereof, with a second pressure portion 176 to press a second shield member 256 provided at the toner cartridge 200 when the toner cartridge 200 is coupled to the developing cartridge 100. Also, the side cover 172 is protrusively formed, at a side portion thereof, with a guide portion 180 to regulate the relative position between the developing cartridge 100 and the toner cartridge 200 together with the first position regulating member 120 when the toner cartridge 200 is mounted at the main body 20.

The guide portion 180 has a contact surface 182 which comes into contact with a slide portion 260 provided at the toner cartridge 200 when the toner cartridge 200 is mounted. The contact surface 182 comes into contact with the slide portion 260 to regulate the position of the toner cartridge 200 in the upward and downward directions.

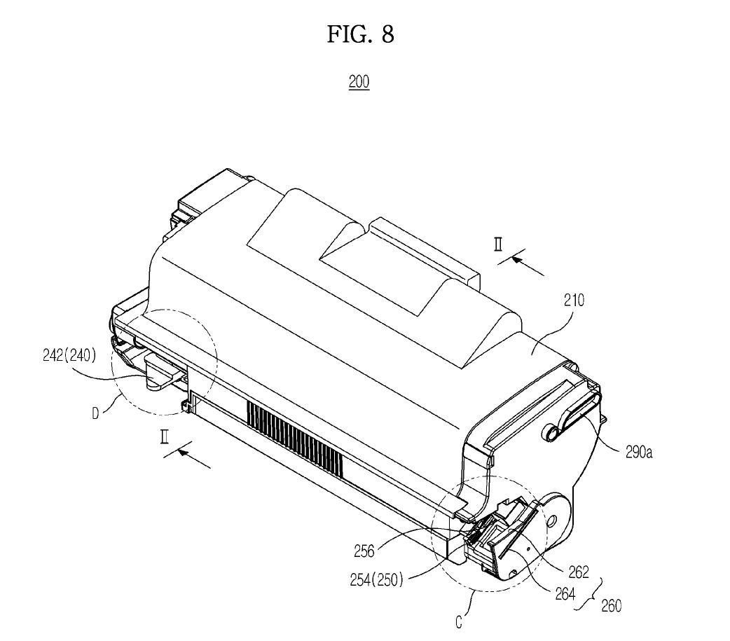

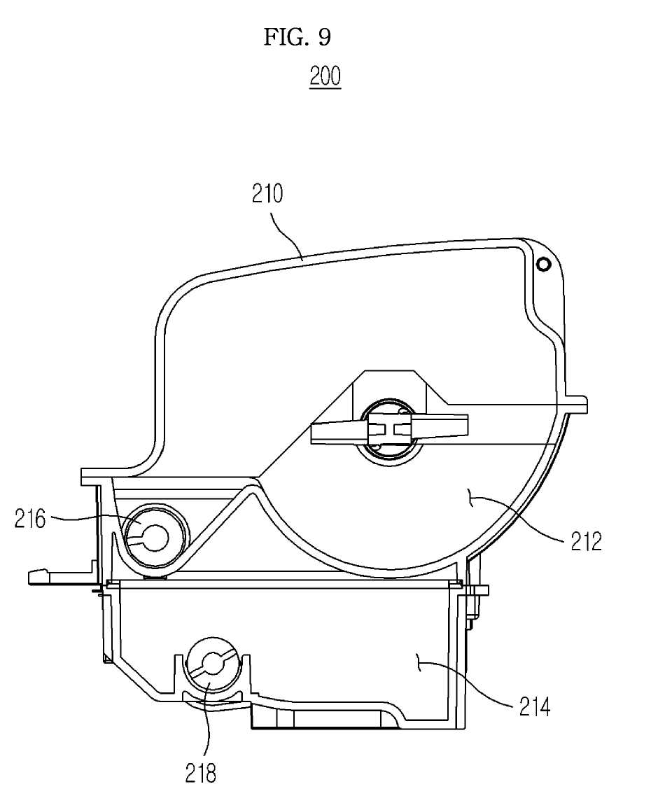

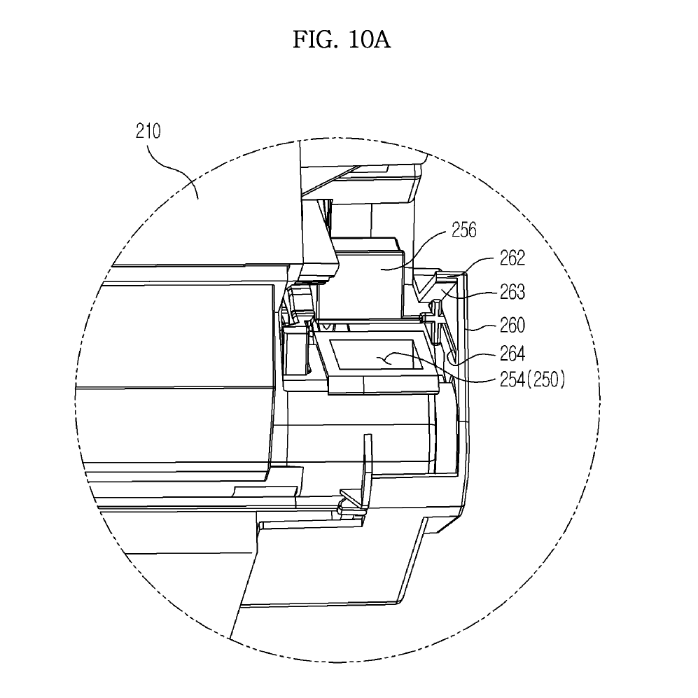

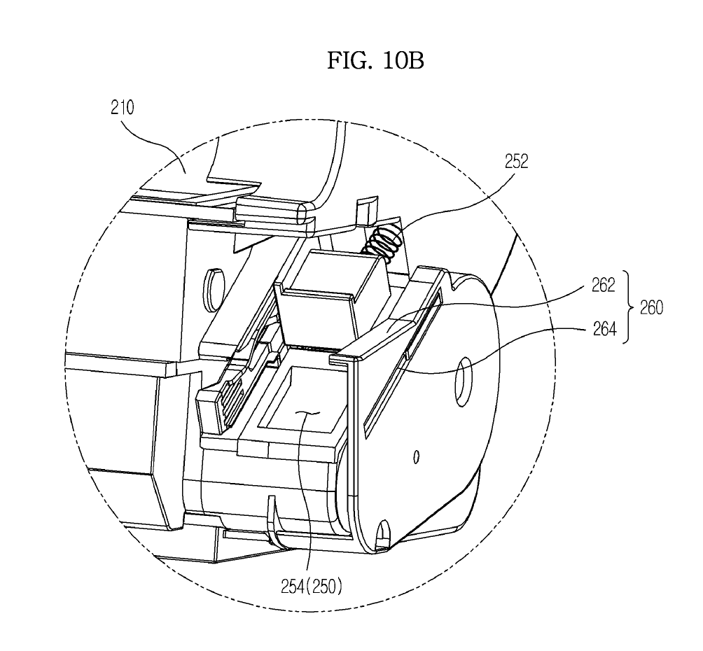

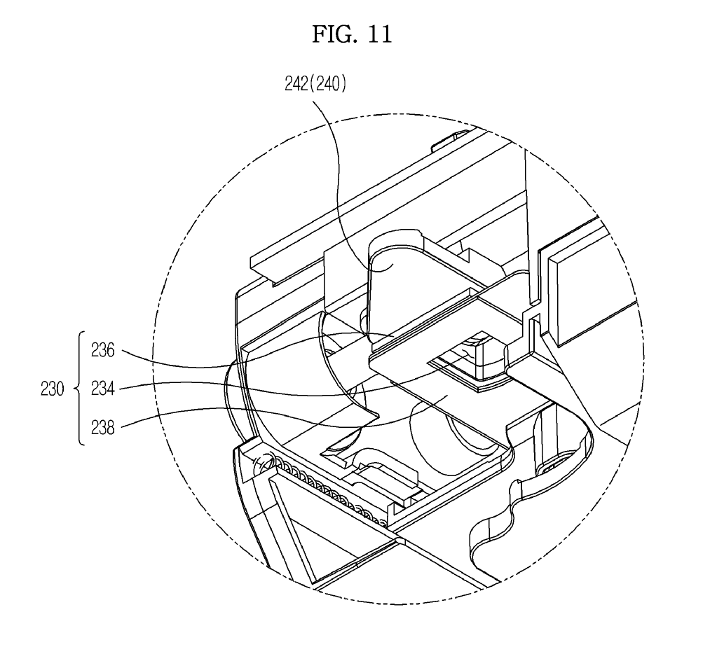

FIG. 8 is a perspective view illustrating the toner cartridge according to an exemplary embodiment of the present general inventive concept. FIG. 9 is a sectional view taken along line II-II of FIG. 8. FIGS. 10A and 10B are expanded perspective views of portion ‘C’ illustrated in FIG. 8 as viewed from different directions. FIG. 11 is an expanded perspective view of portion ‘D’ illustrated in FIG. 8. FIG. 12 is a perspective view illustrating the coupling form of the developing cartridge and the toner cartridge. FIG. 13 is an expanded perspective view of portion ‘E’ illustrated in FIG. 12. FIG. 14 is an expanded perspective view of portion ‘F’ illustrated in FIG. 12. FIG. 15 is a sectional view illustrating the positional relationship between the toner discharge portion and the toner receiving portion when the toner cartridge is mounted.

As illustrated in FIGS. 8 through 15, the toner cartridge 200 includes a housing 210 to define an external appearance thereof, a toner storage portion 212 and a waste toner storage portion 214 provided within the housing 210, a supply toner feeding screw 216 rotatably coupled to opposite sides of the toner storage portion 212, and a second waste toner feeding screw 218 rotatably coupled to opposite sides of the waste toner storage portion 214.

The toner stored in the toner storage portion 212 is fed to one side of the toner storage portion 212 by the supply toner feeding screw 216 to be introduced into the developing cartridge 100 through the toner receiving portion 112. In contrast, the waste toner discharged through the waste toner discharge portion 170 of the developing cartridge 100 is introduced into the waste toner storage portion 214 through a waste toner receiving portion 250. The second waste toner feeding screw 218 serves to evenly disperse the waste toner introduced into the waste toner storage portion 214 within the waste toner storage portion 214.

The housing 210 is provided with the toner discharge portion 230 to supply the toner carried by the toner cartridge 200 to the developing cartridge 100, and the waste toner receiving portion 250 to receive the waste toner discharged from the developing cartridge 100.

The toner discharge portion 230 includes a toner outlet 234 to supply toner through the toner inlet 114, and a first pressure portion 236 to press the first shield member 118. The toner outlet 234 is located at a position to communicate with the toner inlet 114 when the toner cartridge 200 is mounted at the main body 20 to allow the toner stored in the toner storage portion 212 to be introduced into the housing 110 of the developing cartridge 100. The first pressure portion 236 is provided at a front portion of the toner discharge portion 230 to press the first shield member 118 when the toner cartridge 200 is coupled to the developing cartridge 100, thereby allowing the first shield member 118 to open the toner inlet 114.

As illustrated in FIG. 15, the toner discharge portion 230 is coupled, at a lower surface thereof, with a second sealing member 238. The second sealing member 238 prevents the toner from leaking between the toner discharge portion 230 and the toner inlet 114. Meanwhile, the second sealing member 238 is provided, at a lower portion thereof, with a shutter 239 to selectively block the toner outlet 234.

In addition, the toner discharge portion 230 is provided with the second position regulating member 240 to regulate the relative position between the developing cartridge 100 and the toner cartridge 200 when the toner cartridge 200 is mounted at the main body 20.

The second position regulating member 240 has a protrusion 242 which protrudes from the front portion of the toner discharge portion 230 in a mounting direction of the toner cartridge 200. The protrusion 242 is received at the receiving portion 124 of the first position regulating member 120 when the developing cartridge 100 and is coupled to the toner cartridge 200, thereby regulating the position of the toner cartridge 200. That is, the cover portion 126 that forms the receiving portion 124 restrains the toner cartridge 200 from moving in the upward and downward directions, and the side wall portion 128 connected to one side or both sides of the cover portion 126 restrains the toner cartridge 200 from moving in the left and right directions.

The waste toner receiving portion 250 is provided at one side of the housing 210 and includes a waste toner inlet 254. The waste toner inlet 254 comes into contact with the waste toner outlet 174 at a position communicating with the waste toner outlet 174 when the developing cartridge 100 and is coupled to the toner cartridge 200 so that the waste toner discharged through the waste toner outlet 174 may be introduced into the waste toner storage portion 214.

The second shield member 256 is located at a periphery of the waste toner receiving portion 250 to selectively open and close the waste toner inlet 254. The second shield member 256 slidably moves along a guide slot 264 formed at the slide portion 260 and is coupled, at one end thereof, with an elastic member 252. Consequently, the second shield member 256 is elastically biased by the elastic member 252 to close the waste toner inlet 254 in the state in which the toner cartridge 200 is not coupled to the developing cartridge 100. On the other hand, the second shield member 256 is pressed by the second pressure portion 176 provided at the developing cartridge 100 to open the waste toner inlet 254 in the state in which the toner cartridge 200 is coupled to the developing cartridge 100. When replacing the toner cartridge 200, a user separates the developing cartridge 100 from the toner cartridge 200. Accordingly, the second shield member 256 closes the waste toner inlet 254 when the developing cartridge 100 is separated from the toner cartridge 200, as described above. Therefore, the waste toner does not leak through the waste toner inlet 254 during replacement of the toner cartridge 200.

Furthermore, the waste toner receiving portion 250 is provided, at an outer side thereof, with the slide portion 260 to regulate the relative position between the developing cartridge 100 and the toner cartridge 200 when the toner cartridge 200 is mounted at the main body 20.

The slide portion 260 includes a bent portion 262 which is bent from the outer side of the waste toner receiving portion 250 towards the waste toner receiving portion 250, and a guide slot 264 to which the second shield member 256 is coupled and along which the second shield member 256 moves. The bent portion 262 slidably moves along the contact surface 182 of the guide portion 180 formed at the developing cartridge 100 while being supported, at an inner surface thereof, by the contact surface 182 when the toner cartridge 200 is mounted, thereby regulating the position of the toner cartridge 200 in the upward and downward directions.

As described above, during the mounting of the developing cartridge 100 and the toner cartridge 200 at the main body 20, the first position regulating member 120 comes into contact with the second position regulating member 240 to regulate the relative position between the developing cartridge 100 and the toner cartridge 200. Consequently, since the toner receiving portion 112 comes into contact with the toner discharge portion 230 at an exact position, a uniform amount of toner is stably supplied. As a result, toner does not leak between the toner receiving portion 112 and the toner discharge portion 230.

In addition, the guide portion 180 and the slide portion 260 come into contact with each other to regulate the relative position between the developing cartridge 100 and the toner cartridge 200. Consequently, since the waste toner discharge portion 170 comes into contact with the waste toner receiving portion 250 at an exact position, the waste toner does not leak between the waste toner discharge portion 170 and the waste toner receiving portion 250.

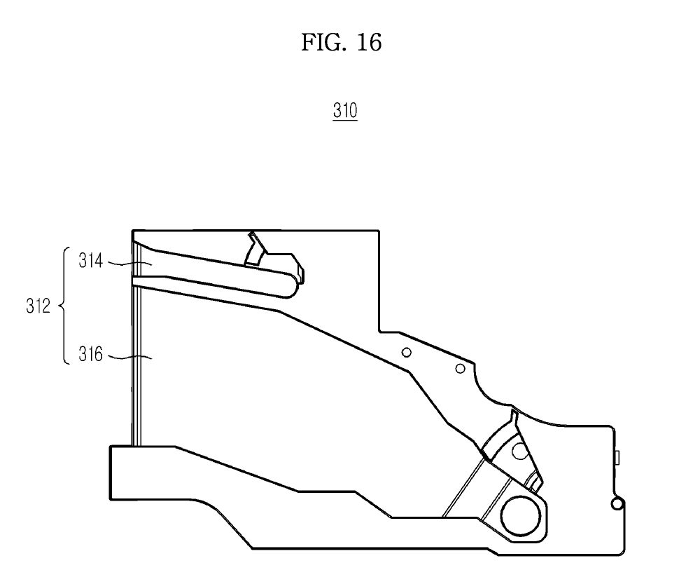

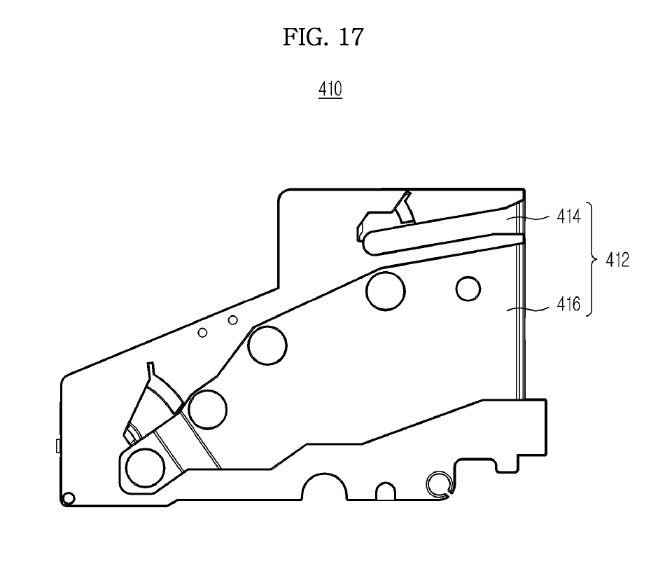

FIG. 16 is a side view separately illustrating a left guide member 310 illustrated in FIG. 2. FIG. 17 is a side view separately illustrating a right guide member 410 illustrated in FIG. 2.

As illustrated in FIGS. 2, 16, and 17, the main body 20 is coupled, at opposite side surfaces thereof, with guide members 310 and 410 to guide the developing cartridge 100 and the toner cartridge 200, respectively.

The guide members 310 and 410 are respectively provided with guide grooves 312 and 412 to define a mounting route of the developing cartridge 100 and the toner cartridge 200. When the developing cartridge 100 and the toner cartridge 200 are mounted at the main body 20, the guide grooves 312 and 412 receive or come into contact with guide protrusions 190a, 190b, and 290a, which protrude from opposite side surfaces of the respective developing cartridge 100 and the toner cartridge 200, and the guide grooves 312 and 412 also receive or come into contact with a guide protrusion 290b, which protrudes from one side surface of the toner cartridge 200, and the slide portion 260, respectively.

The guide grooves 312 and 412 include respective upper guide grooves 314 and 414 and respective lower guide grooves 316 and 416. The upper guide grooves 314 and 414 guide or support the guide protrusions 290a of the toner cartridge 200, whereas the lower guide grooves 316 and 416 guide or support the guide protrusions 190a and 190b of the developing cartridge 100 while respectively guiding or supporting the guide protrusion 290b of the toner cartridge 200 and the slide portion 260. The upper guide grooves 314 and 414 support and seat the guide protrusions 290a in a state in which the developing and toner cartridges 100 and 200 are mounted at the main body 20, whereas the lower guide grooves 316 and 416 support and seat the guide protrusions 190a and 190b while respectively supporting and seating the guide protrusion 290b and the slide portion 260 when the developing cartridge 100 and the toner cartridge 200 are mounted at the main body 20. Consequently, the guide protrusions 190a, 190b, 290a, and 290b, and the slide portion 260 may be arranged at an exact position, thereby regulating a positional relationship between the developing cartridge 100 and the toner cartridge 200 in the main body 20.

Meanwhile, the guide protrusions 190a, 190b, and 290b may be respectively provided, at respective inner sides of thereof, with drive couplers 192 and 292 to rotate a variety of rollers within the developing cartridge 100 and the toner cartridge 200 when the developing cartridge 100 and the toner cartridge 200 are mounted within the main body 20.

As is apparent from the above description, in accordance with the exemplary embodiments of the present general inventive concept, the developing and toner cartridges are regulated at a constant position. As a result, the toner or the waste toner may be smoothly fed from the developing cartridge to the toner cartridge or vice versa, and it may be possible to prevent the toner or the waste toner from leaking out of the developing cartridge or the toner cartridge.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a main body;
a developing cartridge detachably mounted at the main body, and having a photosensitive body to form an electrostatic latent image;
a toner cartridge detachably mounted at the main body to supply the developing cartridge with toner;
at least one first position regulating member provided at the developing cartridge, the first position regulating member to regulate a relative position between the developing cartridge and the toner cartridge when the toner cartridge is mounted at the main body; and
at least one second position regulating member provided at the toner cartridge, the second position regulating member to come into contact with the first position regulating member to regulate the relative position between the developing cartridge and the toner cartridge.

2. The image forming apparatus according to claim 1, wherein:
the developing cartridge comprises a toner receiving portion which is supplied with the toner from the toner cartridge;
the toner cartridge comprises a toner discharge portion to supply the toner through the toner receiving portion; and
the first and second position regulating members come into contact with each other to regulate a positional relationship between the toner receiving portion and the toner discharge portion.

3. The image forming apparatus according to claim 1, wherein:
the developing cartridge comprises a waste toner discharge portion to discharge waste toner to the toner cartridge;
the toner cartridge comprises a waste toner receiving portion to receive the waste toner discharged through the waste toner discharge portion; and
the first and second position regulating members come into contact with each other to regulate a positional relationship between the waste toner discharge portion and the waste toner receiving portion.

4. The image forming apparatus according to claim 2, wherein the first position regulating member has a receiving portion provided at a periphery of the toner receiving portion to receive the second position regulating member when the toner cartridge is mounted at the main body.

5. The image forming apparatus according to claim 4, wherein the second position regulating member has a protrusion which protrudes from a front portion of the toner discharge portion in a mounting direction of the toner cartridge, and the protrusion is received at the receiving portion when the toner cartridge is mounted at the main body.

6. The image forming apparatus according to claim 5, wherein the receiving portion comprises a cover portion to regulate a position of the protrusion in upward and downward directions, and a side wall portion connected with one side or both sides of the cover portion to regulate a position of the protrusion in left and right directions.

7. The image forming apparatus according to claim 6, wherein:
the toner receiving portion is provided, at an upper portion thereof, with a first shield member to selectively block the toner receiving portion; and
the toner discharge portion is provided, at the front portion thereof, with a first pressure portion to press and move the first shield member when the toner cartridge is mounted.

8. The image forming apparatus according to claim 3, wherein the first position regulating member has a guide portion provided at one side of the waste toner discharge portion to guide the second position regulating member when the toner cartridge is mounted at the main body.

9. The image forming apparatus according to claim 8, wherein the second position regulating member has a slide portion provided at a periphery of the waste toner receiving portion to come into contact with the guide portion when the toner cartridge is mounted at the main body so as to slide in a mounting direction of the toner cartridge.

10. The image forming apparatus according to claim 9, wherein the waste toner discharge portion comprises:
a side cover coupled to one side of a housing;
a waste toner feeding belt to feed the waste toner received at a space which is defined by the housing and the side cover; and
a waste toner outlet to which the waste toner fed by the waste toner feeding belt is discharged,
wherein the guide portion has a contact surface formed to protrude from one side of the side cover to come into contact with the slide portion.

11. The image forming apparatus according to claim 10, wherein:
the waste toner receiving portion is provided, at an upper portion thereof, with a second shield member to selectively block the waste toner receiving portion; and
the side cover is provided, at a front portion thereof, with a second pressure portion to press and move the second shield member when the toner cartridge is mounted.

12. The image forming apparatus according to claim 1, wherein:
the main body is coupled, at opposite sides thereof, with guide members so as to guide the developing cartridge or the toner cartridge, each of the guide members having at least one guide groove; and
the developing cartridge or the toner cartridge is provided, at each of opposite sides thereof, with at least one guide protrusion, which is received at the guide groove when the developing cartridge is mounted at the main body.

13. The image forming apparatus according to claim 12, wherein the guide groove comprises an upper guide groove to support the toner cartridge and a lower guide groove to support the developing cartridge or the toner cartridge.

14. The image forming apparatus according to claim 13, wherein the at least one guide protrusion, which is provided at each of the opposite sides of the developing cartridge or the toner cartridge, is provided, at an inner side thereof, with a drive coupler to rotate rollers within the developing cartridge or the toner cartridge.

15. A developing unit including a developing cartridge to form an image on a printing medium and a toner cartridge to supply the developing cartridge with toner, the developing cartridge comprising:
a housing comprising a toner receiving portion and a waste toner discharge portion;
a photosensitive body rotatably coupled within the housing to form an electrostatic latent image;
at least one agitating screw to agitate the toner supplied through the toner receiving portion to feed the toner to the photosensitive body;
a cleaning member to remove waste toner remaining on the photosensitive body;
a waste toner feeding screw to feed the waste toner removed by the cleaning member to one side of the housing;
a waste toner feeding belt to guide the waste toner fed by the waste toner feeding screw to the waste toner discharge portion; and
at least one first position regulating member provided at a periphery of the waste toner discharge portion, the first position regulating member coming into contact with the toner cartridge to regulate a relative position between the developing cartridge and the toner cartridge.

16. The developing unit according to claim 15, wherein the toner cartridge comprises:
a waste toner receiving portion to come into contact with the waste toner discharge portion to receive the waste toner discharged through the waste toner discharge portion; and
at least one second position regulating member provided at a periphery of the waste toner receiving portion, the second position regulating member coming into contact with the first position regulating member to regulate the relative position between the developing cartridge and the toner cartridge.

17. The developing unit according to claim 16, wherein the first position regulating member has a guide portion which protrudes from one side of the waste toner discharge portion to guide the second position regulating member when the toner cartridge is mounted at the main body.

18. The developing unit according to claim 17, wherein the second position regulating member has a slide portion which is provided at the periphery of the waste toner receiving portion to come into contact with the guide portion when the toner cartridge is mounted at the main body so as to slide in a mounting direction of the toner cartridge.

19. A developing unit including a developing cartridge to form an image on a printing medium and a toner cartridge to supply the developing cartridge with toner, the developing cartridge comprising:
a housing comprising a toner receiving portion;
a photosensitive body rotatably coupled within the housing to form an electrostatic latent image;
at least one agitating screw to agitate the toner supplied through the toner receiving portion to feed the toner to the photosensitive body; and
at least one first position regulating member provided at a periphery of the waste toner discharge portion, the first position regulating member coming into contact with the toner cartridge to regulate a relative position between the developing cartridge and the toner cartridge.

20. The developing unit according to claim 19, wherein the toner cartridge comprises:
a toner supply portion to come into contact with the toner receiving portion to supply the toner receiving portion with the toner; and
at least one second position regulating member provided at one side of the toner supply portion, the second position regulating member coming into contact with the first position regulating member to regulate the relative position between the developing cartridge and the toner cartridge.

21. The developing unit according to claim 20, wherein:
the first position regulating member has a receiving portion to receive the second position regulating member when the toner cartridge is mounted at the main body; and
the receiving portion comprises a cover portion to regulate a position of the second position regulating member in upward and downward directions.

22. The developing unit according to claim 21, wherein the second position regulating member has a protrusion which protrudes from a front portion of the toner discharge portion in a mounting direction of the toner cartridge, and the protrusion is received at the receiving portion when the toner cartridge is mounted at the main body.

23. An image forming apparatus, comprising:
a developing cartridge to supply toner to a printing medium;
a toner cartridge detachably coupled to the developing cartridge to supply the developing cartridge with the toner; and
a position regulating member to regulate a relative position between the developing cartridge and the toner cartridge when the toner cartridge is coupled to the developing cartridge.
